(19) United States
(12) Patent Application Publication
(10) Pub. No.: US 2005/0032670 A1
(43) Pub. Date: Feb. 10, 2005

(54) Cleaning agent for the removal of chewing gum residues, and method of preparing the same

(76) Inventor: Gerardus Wilhelmus Maria Besseling, Huizen (NL)

Correspondence Address: BLANK ROME LLP, THE FARRAGUT BUILDING SUITE 1000, 900 17TH STREET NW, WASHINGTON, DC, 20006, US

(21) Appl. No.: 10/296,501

(22) PCT Filed: May 28, 2001
(86) PCT No.: PCT/NL01/00411

(30) Foreign Application Priority Data
May 26, 2000 (NL) 1015316

(51) Int. Cl. C11D 7/02

(52) U.S. Cl. 510/510

(57) ABSTRACT

The present invention relates to a cleaning agent for use in the steam-assisted removal of chewing gum, and to the preparation of the cleaning agent. The cleaning agent according to the invention is an aqueous solution which comprises phosphate compounds comprising a combination of at least orthophosphate, polyphosphate and pyrophosphate, and which further comprises at least one anionic surfactant, an apolar organic solvent and an emulsifier.

The present invention relates to a cleaning agent for the removal of chewing gum residuses.

Discarded chewing gum residues represent a common form of fouling of floor and ground surfaces, but also of furniture such as benches and tables, both indoors and outdoors, in the street, in parks and other spaces accessible to the public. In the most favourable case, this fouling is concentrated around waste bins and drain holes, but in general the problem of chewing gum fouling occurs everywhere. Furthermore, chewing gum discarded outside is often “dragged” back into buildings and the like, where it adheres to floor coverings, carpets, doormats etc. These chewing gum residues are very difficult to remove because of their strong adhesion. Furthermore, the longer the chewing gum residues remain, the harder they become and the more difficult they are to remove. It is also known that sugary chewing gum is more difficult to remove than sugar-free chewing gum.

A technique known in the art for removing chewing gum residues is based on drastic cooling of the chewing gum residues with the aid of liquid nitrogen to a temperature at which the chewing gum becomes hard and brittle (about −50° C.), so that the chewing gum can then be crumbled and be collected and removed.

However, this cryogenic technique has a number of drawbacks. First of all, this technique makes use of large equipment producing a lot of noise, said noise causing a nuisance to the public and in the surroundings, and access to the locations in question is hindered. The removal of chewing gum with the aid of this technique must therefore be carried out, as far as possible, outside opening times and during quiet hours (at night). A further drawback is that this technique, owing to the drastic cooling, entails the risk of damage to the objects to be cleaned, e.g. rubber articles and other delicate components. Furthermore, this technique is expensive, because it is very labour-intensive and because of the limited capacity and the high cost price of the materials and equipment used.

Another recent proposal, in WO98/00608, is to remove chewing gum by directing a jet of steam of sufficiently high temperature and sufficiently high pressure at the separate patches of chewing gum, so that the steam penetrates into the chewing gum and causes it to disintegrate. This treatment is preferably carried out with steam of at least 140° C. and with a steam pressure of less than 50 bar, so that the substrate is not damaged. The disintegrated chewing gum residues are swept up after cooling or are collected by means of vacuuming.

In practice, however, this technique has been found to entail a number of drawbacks. This technique is labour-intensive, because the disintegrated chewing gum residues must, after cooling, be collected in an additional step which, on the one hand, cannot take place immediately after the steam treatment, because the chewing gum residues, which are still hot, then adhere to the broom, sweeping or vacuuming means—after all, they have not lost their tack. On the other hand, too long a wait before collection of the disintegrated chewing gum residues is not practical either, since otherwise these would again adhere to the substrate. Moreover, the steam pressure used (about 48 bar) is so high that the area to be cleaned has to be fenced off, there is the risk that sand and the like is flushed out from in between the paving and, so that the paving stones or tiles will come loose. In addition, building up the necessary pressure requires a powerful and consequently relatively expensive pump, which gives rise to sound pollution of the surroundings. In addition it is stated that the water consumption is about 3-3.5 litres per minute, if the lance used is operated continuously, while intermittent use requires about half that. This means that a relatively large supply of water must be present as well as a powerful boiler of sufficient capacity for converting this water into steam.

DE-C-26 13 326 discloses a similar method of removing chewing gum residues and of killing (pathogenic) germs, which involves water at high pressure and a temperature above 90° C. being directed onto each patch of chewing gum to be removed. The description also states that the water can be mixed with an antibacterial agent.

The object of the present invention is to provide a cleaning agent for the removal of chewing gum residues which, when applied in conjunction with the use of steam, exhibits the abovementioned drawbacks of the cryogenic technique and steam technique to a lesser extent or does not exhibit them at all.

The cleaning agent for the removal of chewing gum according to the invention is defined in claim 1.

The cleaning agent according to the invention is an aqueous solution which contains a number of inorganic salts and organic components.

The phosphate compounds should consist of a combination of at least orthophosphate PO₄³⁻, polyphosphate P₂O₇⁴⁻ and pyrophosphate P₃O₁₀⁵⁻, of which the alkaline earth metal salts, especially sodium salts, are preferably used. The ratio of ortho-phosphate:polyphosphate:pyrophosphate is advantageously in the range of 1:10-20:5-13 with a view to the rate of removal.

The cleaning agent according to the invention further comprises an anionic surfactant. Examples of suitable anionic surfactants are the conventional alkali metal and ammonium compounds of carboxylates (RCOO⁻M⁺, where R is a straight C₉-C₂₁ hydrocarbon chain and M represents an (alkali) metal ion or ammonium ion), alkyl-, aryl- or alkylarylsulphonates which may or may not be substituted (which contain an SO₃M group) and sulphates and sulphated products (which contain an —OSO₃M group). Preference is given to the use of sulphur-containing anionic surfactants, because these are less pH-sensitive. Examples of sulphonates include, inter alia, alkylbenzenesulphonates, alkylarene-sulphonates, short-chain lignosulphates, naphthalenesulphonates, alpha-olefinesulphonates, and sulphonates containing ester, amide or ether bonds. The sulphates include, inter alia, (ethoxylated and sulphated) alkylphenols, sulphated acids, amides and esters and sulphated oils and fats. Alkylbenzenesulphonates are the most preferred.

A mixture of anionic surfactants and non-ionic surfactants can also be used. Suitable non-ionic surfactants comprise ethoxylates (polyoxyethylene surfactants), including alcohol and alkylphenol ethoxylates, carboxylic acid esters such as glycerol esters and polyoxyethylene esters and ethoxylated glycol esters of fatty acids, and polyalkylene oxide block copolymers containing a —CH(CH₃)CH₂O—unit.

The cleaning agent also contains a small amount of organic solvent, preferably an apolar solvent which is primarily able to bind apolar particles. Preferably, the organic solvent is a petroleum fraction obtained by distillation of crude oil, predominantly consisting of saturated C₁₁-C₁₆ hydrocarbons having boiling points in the range of about 190-290° C. In particular, a distillate of linear, isocyclic and cyclic C₁₁-C₁₃ hydrocarbons having boiling points in the range of 196-245° C. is used. Because of the absence of double bonds in the saturated hydrocarbons, these are readily biodegradable, and their use does not give rise to environmental problems.

To emulsify the apolar saturated hydrocarbons of the solvent used in the polar water, the cleaning agent further comprises an emulsifier. Examples of such emulsifiers comprise the abovementioned non-ionic surfactants and, in particular, the polyethylene glycols (HO—CH₂—CH₂—(O—CH₂—CH₂)ₙ—O—CH₂—CH₂—OH) which are likewise readily biodegradable.

With a view to the stability of the cleaning agent according to the present invention and to the rate of removal, the ratios of organic solvent:emulsifier and surfactant:organic solvent, respectively, are preferably in the range of 1:0.1-1.0 and 1:1-4, respectively.

It was found that the higher the alkalinity of the cleaning agent, the less effectively the chewing gum will be removed. During use, the cleaning agent therefore preferably has a pH in the range of 7.5-10.5, more preferably 7.5-8.5.

To remove chewing gum, it is first heated, preferably by means of superheated steam, and the cleaning agent according to the invention is then injected into the steam and thus applied to the chewing gum residue. A violent reaction then takes place between the chewing gum and the cleaning agent, the chewing gum being completely consumed in the reaction and/or being completely dissolved. Any residues which, in the case of very large patches of chewing gum, might remain in the form of short threads are no longer tacky and can, if required, be removed in a conventional manner.

One of the advantages of the use of steam is that only a small amount of this is required—50 l per 200-400 m² of area to be cleaned—for the clean surface to be dry almost immediately and to be capable of being walked on again. To implement the cleaning method, use can be made of commercially available low-pressure steam cleaners (max. 10 bar) . These produce virtually no noise and consequently cause no sound pollution in the surroundings. Low-pressure operation moreover prevents paving and the like from coming loose.

The invention also relates to a method of preparing the present cleaning agent as defined in claim 12.

The method according to the invention involves dissolving the inorganic components and the surfactant in water, with vigorous stirring and at elevated temperature if necessary. A mixture of organic solvent and emulsifier is prepared separately and is then added, preferably gradually, to the aqueous solution. Advantageously, this last step is carried out while the aqueous solution and the mixture to be added thereto are kept at a slightly elevated temperature, for example in the range of 30-65° C.

The cleaning agent according to the invention can be used both indoors and outdoors, for example in streets of shops and shopping centres, railway platforms and public transport stops, schools, courtyards, playgrounds, catering establishments, amusement parks, sports complexes, (football) stadiums, petrol stations, airports and entrances. The cleaning agent is suitable for any substrate, including asphalt, concrete, clinker paving stones, natural stone, carpet, floor covering, doormats etc.

The cleaning agent according to the invention and the use thereof for the removal of chewing gum is illustrated below with reference to the following example.

### EXAMPLE

An aqueous solution was prepared by the components listed below being added to 88 litres of water in the amounts and sequential order as stated:

| | | |
|---|---|---|
| Sodium orthophosphate | 0.08 | kg |
| Sodium polyphosphate | 1.00 | kg |
| Sodium pyrophosphate | 1.50 | kg |
| Anionic surfactant | 5 | l |

(about 25% strength aqueous solution)

Also prepared was a mixture of a 4 l petroleum distillate consisting of linear C₁₁-C₁₆ hydrocarbons having boiling points in the range of 194-251° C. and 2 l of PEG emulsifier. The solution thus obtained was warmed slightly (T>25° C.), as was the mixture obtained. The mixture thus heated was added with stirring to the aqueous solution, thus affording a clear solution of a pale grey colour.

One litre of this product was diluted with 4 litres of water and used in a trial for the removal of chewing gum. A test pavement consisting of ordinary paving stones was covered with a large number of chewing gum residues. Each piece of chewing gum was steam-treated with the aid of a low-pressure steam cleaner comprising a lance provided with two ducts for steam and cleaning agent, the cleaning agent duct of said cleaner debauching into the steam duct. Arranged around the nozzle of the lance is a brush. Shortly after the start of steam delivery at a temperature of about 130° C. and a pressure of about 6 bar, the diluted cleaning agent is injected into the steam over a short period and, with the aid of the brush, is applied to the patch of chewing gum. During the subsequent reaction between the chewing gum on the one hand and the cleaning agent and steam on the other hand, the patch of chewing gum disappears in its entirety. Any residual chewing gum still present is no longer tacky.

One litre of the solution thus diluted is sufficient for cleaning an area of about 13 m² heavily fouled with chewing gum residues.

1. Cleaning agent for the removal of chewing gum residues, the agent being an aqueous solution which comprises phosphate compounds comprising a combination of at least orthophosphate, polyphosphate and pyrophosphate, and which further comprises at least one anionic surfactant, an apolar organic solvent and an emulsifier.

2. Cleaning agent according to claim 1, wherein the cleaning agent also includes a non-ionic surfactant.

3. Cleaning agent according to claim 1, wherein the weight ratio of orthophosphate:polyphosphate:pyrophosphate is in the range of 1:10-20:5-13.

4. Cleaning agent according to claim 1, wherein the anionic surfactant is selected from the group consisting of sulphonate- or sulphate-containing anionic surfactants.

5. Cleaning agent according to claim 1, wherein the apolar organic solvent is a petroleum distillate which predominantly comprises saturated C₁₁-C₁₆ hydrocarbons, with a boiling range of 190-290° C.

6. Cleaning agent according to claim 5, wherein the petroleum distillate is a mixture of linear, isocyclic and cyclic C₁₁-C₁₃ hydrocarbons having boiling points in the range of 196-245° C.

7. Cleaning agent according to claim 1, wherein the emulsifier is selected from the group of non-ionic surfactants.

8. Cleaning agent according to claim 1, wherein the emulsifier is a polyethylene glycol.

9. Cleaning agent according to claim 1, wherein the ratio of organic solvent:emulsifier is in the range of 1:0.3-1.

10. Cleaning agent according to claim 1, wherein the ratio of surfactant:organic solvent is in the range of 1:2-4.

11. Cleaning agent according to claim 1, wherein in use the pH of the agent is in the range of 7.5 to 10.5, more particularly 7.5-8.5.
